(19) United States
(12) Patent Application Publication
(10) Pub. No.: US 2015/0081638 A1
(43) Pub. Date: Mar. 19, 2015

(54) Video Storage System

(71) Applicants: Sheng-Fu Chang, Taichung City (TW); Hsien-Hsiu Wang, Taichung City (TW)

(72) Inventors: Sheng-Fu Chang, Taichung City (TW); Hsien-Hsiu Wang, Taichung City (TW)

(21) Appl. No.: 14/030,848

(22) Filed: Sep. 18, 2013

(51) Int. Cl. G06F 17/30; G06F 11/14

(52) U.S. Cl. CPC G06F 17/30943; G06F 11/1446
USPC 707/640; 707/736

(57) ABSTRACT

A video storage system includes a CVR manager including a software program of management run therein, at least two IP cameras connected to the CVR manager via the Internet; and at least two CVR units connected to the CVR manager via the Internet. The CVR manager assigns each of the CVR units to store a file of video data produced by a corresponding one of the IP cameras. Thus, the CVR manager distributes the video data produced by the cameras to the CVR units. Hence, the video storage system is inexpensive and highly expansible.

### BACKGROUND OF INVENTION

1. Field of Invention

The present invention relates to a video storage system and, more particularly, to a video storage system based on cloud computing.

2. Related Prior Art

Service based on cloud computing is developing as computers and the Internet are developing. Storage based on cloud computing allows a user to store data on servers via the Internet. There is no need for bulky centralized storage devices. Moreover, the availability of the data is improved. Hence, storage based on cloud computing is used for documents, video data and audio data on the Internet.

IP cameras may be used for surveillance at intersections, schools, malls, homes, and resultant video data may be stored in a storage device via a server. Generally, a large corporate owns a large centralized storage device for storing the video data of its customers. However, it is too expensive and difficult for a small company to own a large centralized storage device in addition to the IP cameras, and the problem with the high cost of a large centralized storage device only gets worse since the demand for the capacity of the storage of the video data gets higher because the quantity of the video data increases as the IP cameras continue to produce video data.

Therefore, the present invention is intended to obviate or at least alleviate the problems encountered in prior art.

### SUMMARY OF INVENTION

It is the primary objective of the present invention to provide a video storage system based on cloud computing.

To achieve the foregoing objective, the video storage system includes a CVR manager including a software program of management run therein, at least two IP cameras connected to the CVR manager via the Internet; and at least two CVR units connected to the CVR manager via the Internet. The CVR manager assigns each of the CVR units to store a file of video data produced by a corresponding one of the IP cameras. Thus, the CVR manager distributes the video data produced by the cameras to the CVR units. Hence, the video storage system is inexpensive and highly expansible.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a video storage system based on cloud computing according to the preferred embodiment of the present invention;

FIGS. 2 via 5 are other block diagrams of the storage system shown in FIG. 1 for showing how to assign tasks of producing video data to various IP cameras;

FIGS. 6 to 7 are block diagrams of the storage system shown in FIG. 1 for showing how to assign tasks of storing the video data to various storage devices; and

FIG. 8 is a block diagram of the storage system shown in FIG. 1 for showing how to inquire the video data.

### DETAILED DESCRIPTION OF PREFERRED EMBODIMENT

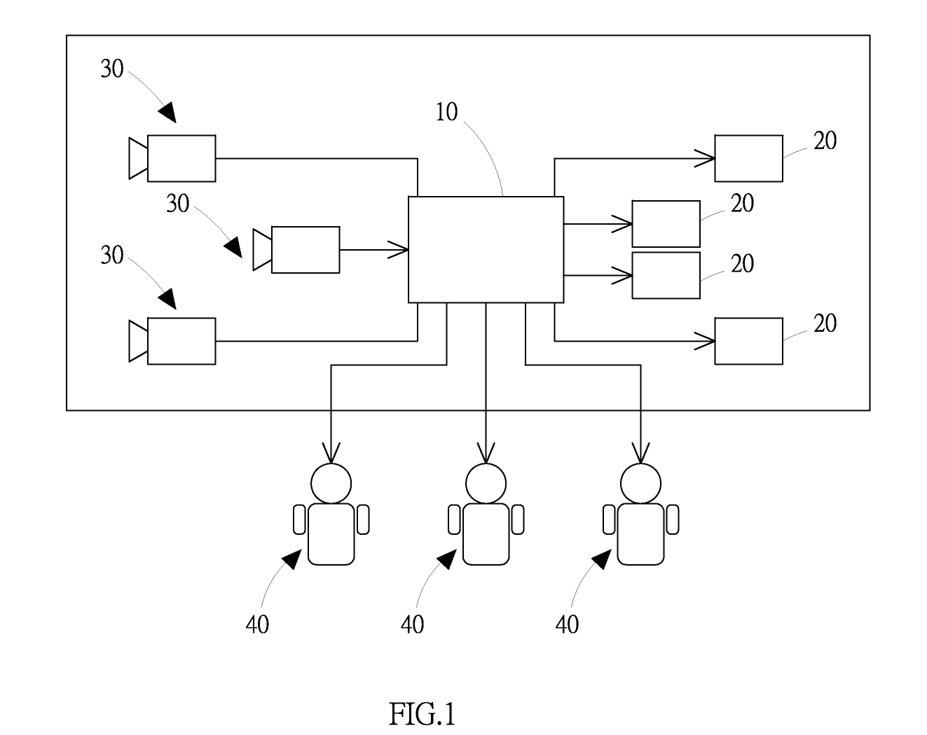

Referring to FIG. 1, there is a video storage system according to the preferred embodiment of the present invention. The video storage system includes a camera video recorder (“CVR”) manager 10 and CVR units 20. The CVR units 20 are connected to the CVR manager 10 via the Internet. IP cameras 30 are also connected to the CVR manager 10 via the Internet. The IP cameras 30 take video footages and accordingly produce video data. The CVR manager 10 assigns the CVR units 20 to record the video data produced by the IP cameras 30. That is, the CVR manager 10 distributes the video data produced by the IP cameras 30 to the CVR units 20. Users 40 can use various devices to access the CVR manager 10 via the Internet. The users 40 can access the video data produced by the IP cameras 30 and stored in the CVR units 20 via the CVR manager 10.

A software program is run in the CVR manager 10 to manage commands, demands, assignments and backup files. The CVR manager 10 includes a database 15 for storing detailed information about the video data under the control of the software program. The detailed information about the video data includes the identification (“ID”) of the IP camera 30, the IP address, the identification of the CVR unit 20 and the time when a video footage is taken.

The CVR units 20 store the video data under the control of the CVR manager 10. Each of the CVR units 20 can be used as a backup unit for another CVR unit 20.

As discussed above, the video storage system of the present invention is inexpensive and highly expansible. The operation of the video storage system includes three tasks. At first, the CVR manager 10 assigns the CVR units 20 to store the video data produced by the IP cameras 30. Secondly, the CVR manager 10 manages and distributes the video produced by the IP cameras 30 to the CVR units 20. Thirdly, the CVR manager 10 allows the users 40 to access the video data.

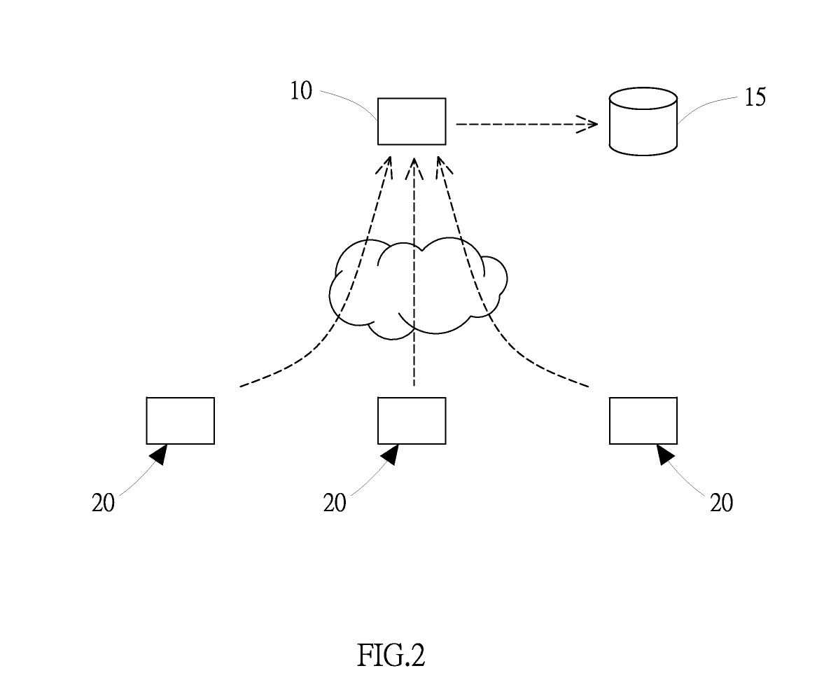

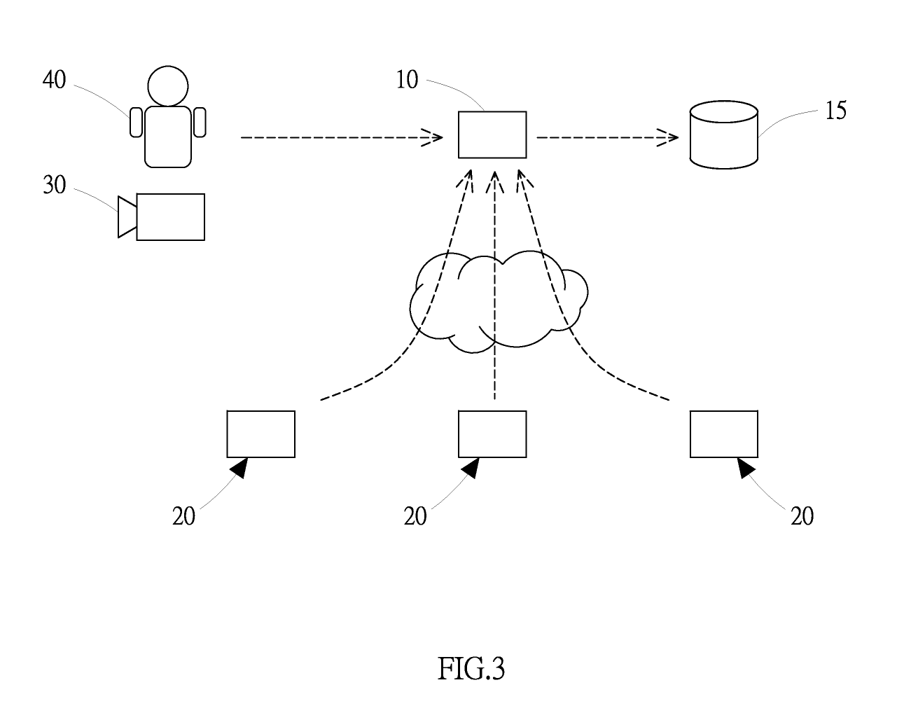

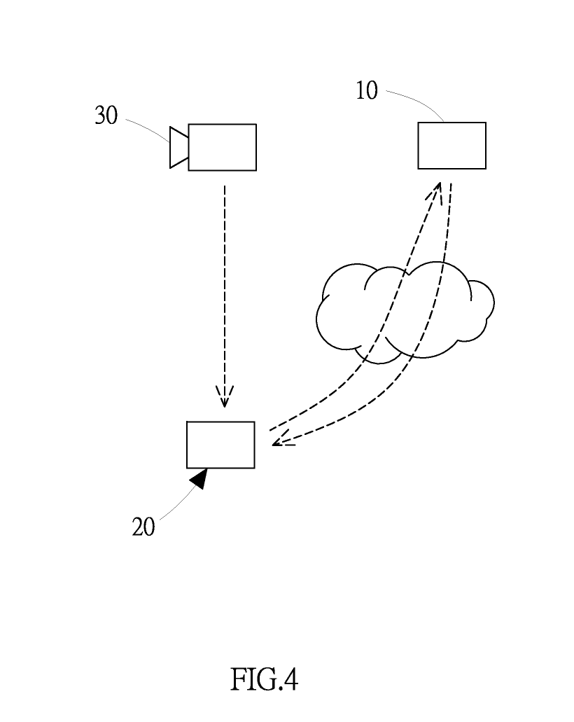

Referring to FIGS. 2 via 5, how the CVR manager 10 assigns the CVR units 20 to store the video data produced by the IP cameras 30 will be described. At first, referring to FIG. 2, all of the CVR units 20 periodically report to the CVR manager 10 after they are lugged on the Internet. Each of the CVR units 20 reports its ID to the CVR manager 10 or the CVR manager 10 assigns an ID to each of the CVR units 20. Thus, the CVR manager 10 knows the ID and location of each of the CVR units 20 and stores them in the database 15.

Secondly, referring to FIG. 3, when there is a demand for taking a video footage, the CVR manager 10 searches the database 15 for a CVR unit 20 (the “prime CVR unit 20”) and provides the prime CVR unit 20 with details of the task of taking a video footage. The details include the location, ID and code of a corresponding IP camera 30. Thus, the prime CVR unit 20 stores video data based on the video footage taken by the corresponding IP camera 30 and produces a file for the video data.

Thirdly, referring to FIG. 4, the prime CVR unit 20 periodically reports its status to the CVR manager 10 during the task of storing the video data. Thus, the CVR manager 10 determines whether the prime CVR unit 20 executes the task of storing the video data normally. Moreover, the CVR manager 10 instructs the prime CVR unit 20 to continue or stop the task of storing the video data.

Fourthly, referring to FIG. 5, the CVR manager 10 continues to monitor the prime CVR unit 20 until the task of storing the video data is completed. In case of failure of the prime CVR unit 20, the CVR manager 10 stops the task for the prime CVR unit 20 and returns the operation of the video storage system to the second step to assign another CVR unit 20 to store the video data.

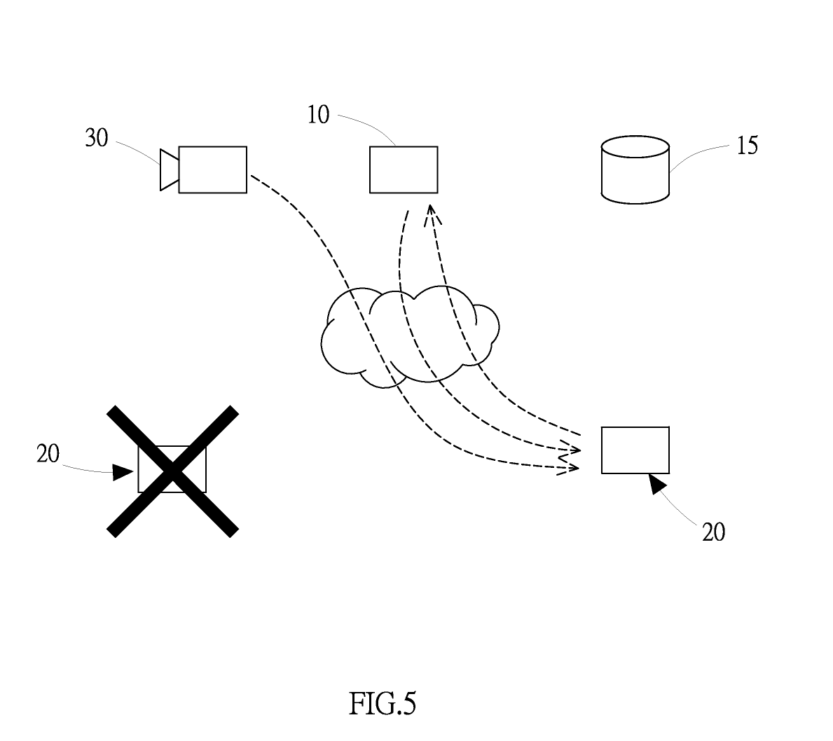

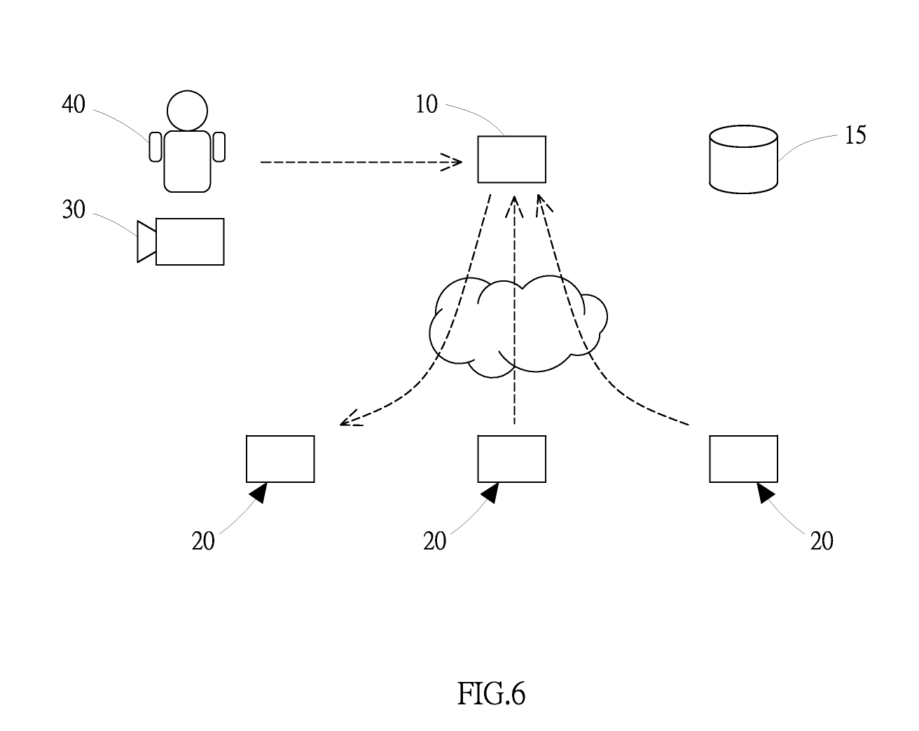

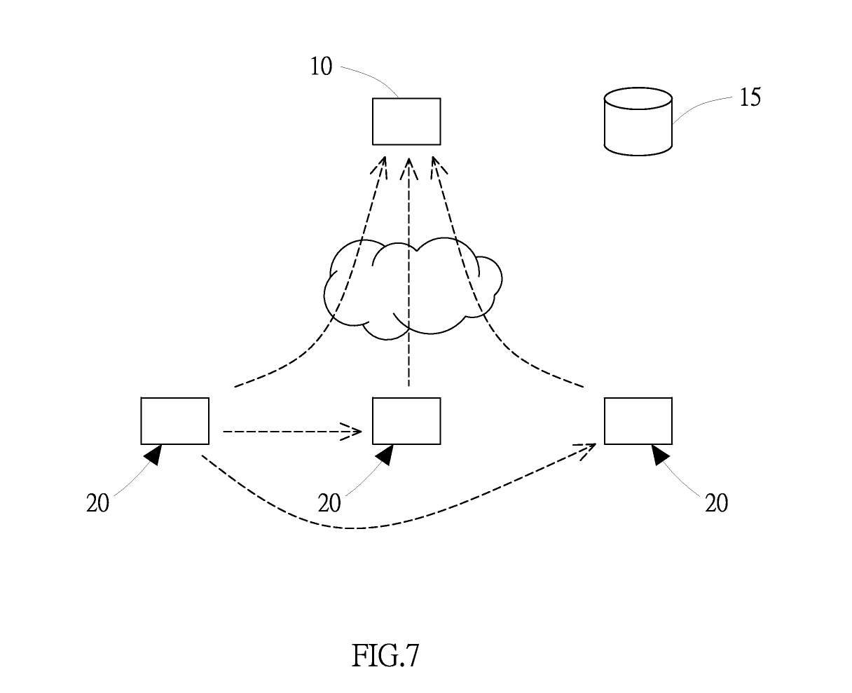

Referring to FIGS. 6 and 7, how the CVR manager 10 manages and distributes the video produced by the IP cameras 30 to the CVR units 20 will be described. Referring to FIG. 6, a user 40 operates to the CVR manager 10 to access to the prime CVR unit 20.

Referring to FIG. 7, all of the CVR units 20 report their statuses to the CVR manager 10. The CVR manager 10 knows that the prime CVR stores a copy of the video data.

Then, the CVR manager 10 stores the information about the statuses of the CVR units 20 in the database 15.

Then, the CVR manager 10 instructs the prime CVR units 20 to provide two copies of the video data in two backup CVR units 20.

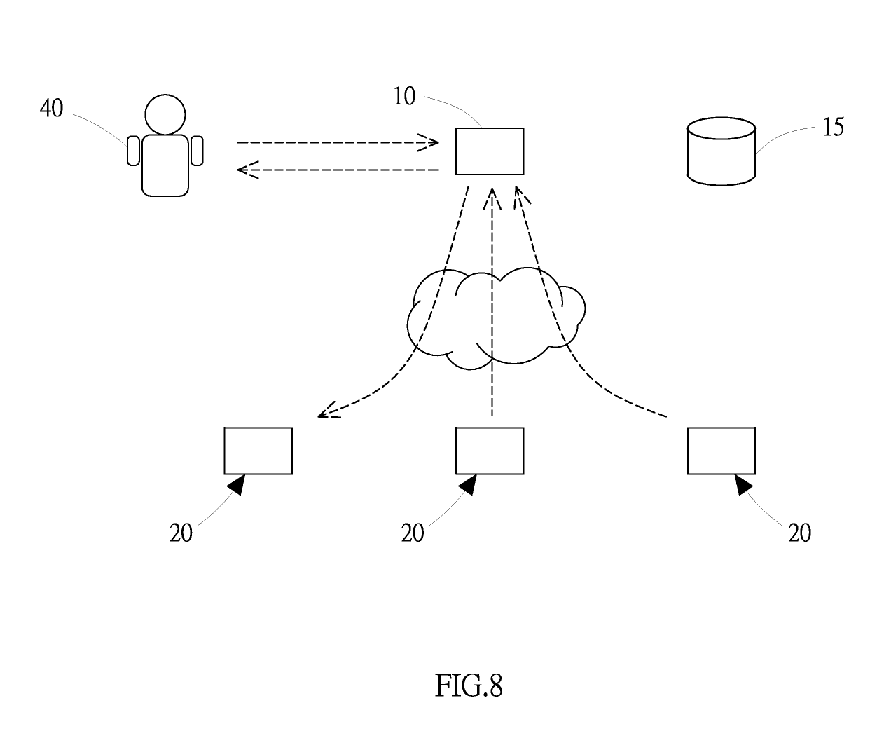

How the user 40 accesses to the video data will be described referring to FIG. 8. At first, the user 40 demands the CVR manager 10 for the video data produced by the prime IP camera 30.

Then, the CVR manager 10 searches the database 15 for the information about the video data. The CVR manager 10 locates the prime CVR unit 20 and the backup CVR units 20 based on the information about the video data.

Then, the user 40 operates the CVR manager 10 to access to at least one of the prime CVR unit 20 and the backup CVR units 20 and get at least one copy of the video data.

In the video storage system of the present invention, the CVR manager 10 assigns the CVR units 20 to store video data produced by the IP cameras 30. Hence, the video data produced by each of the IP cameras 30 are stored in at least a corresponding one of the CVR units 20. The information about the video data produced by each of the IP cameras 30 and the at least one corresponding CVR unit 20 is stored in the database 15. Thus, the users 40 can access to the video data. The CVR units 20 can be provided at any number on demand. The initial cost for the construction of the video storage system is therefore low. Existing CVR units 20 will not be affected when additional CVR units 20 are installed.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A video storage system including:
a CVR manager including a software program of management run therein;
at least two IP cameras connected to the CVR manager via the Internet; and
at least two prime CVR units connected to the CVR manager via the Internet, wherein the CVR manager assigns each of the prime CVR units to store a file of video data produced by a corresponding one of the IP cameras so that the CVR manager distributes the video data produced by the cameras to the prime CVR units and that the video storage system is inexpensive and highly expansible.

2. The video storage system according to claim 1, including at least two backup CVR units, wherein the CVR manager assigns each of the backup CVR units to store a backup copy of the video data identical to the copy of the video data stored in a corresponding one of the prime CVR units.

3. The video storage system according to claim 2, wherein the backup CVR units are connected to the CVR manager via the Internet.

4. The video storage system according to claim 2, wherein each of the backup CVR units is connected to the corresponding prime CVR unit.
